(19) United States
(12) Patent Application Publication
(10) Pub. No.: US 2022/0330048 A1
(43) Pub. Date: Oct. 13, 2022

(54) Support for Reporting Failure of Multiple Rules in PFCP Response Messages

(71) Applicant: Parallel Wireless, Inc., Nashua, NH (US)

(72) Inventor: Ganesh Jaju, Pune (IN)

(21) Appl. No.: 17/711,449

(22) Filed: Apr. 1, 2022

Related U.S. Application Data
(60) Provisional application No. 63/170,163, filed on Apr. 2, 2021.

(51) Int. Cl. H04W 24/02; H04W 28/24; H04W 4/24

(52) U.S. Cl. CPC H04W 24/02; H04W 28/24; H04W 4/24; H04W 84/042

(57) ABSTRACT

A method, computer readable media and a system are disclosed to identify a mechanism to be able to supply multiple “Failed Rule ID” in a single PFCP response message from User Plane (UP) to Control Plane (CP) via the Sx interface for 4G and via the N4 interface for 5G. In one embodiment, a method for operating a wireless network device including a User Plane (UP) and a Control Plane (CP) in communication with the UP, includes configuring, by the CP, multiple rules in the UP; identifying, by the UP, multiple failed rule Identifiers (IDs); supplying, in a single Packet Forwarding Control Protocol (PFCP) response message from the UP to a CP, the multiple failed rule IDs; and determining, by the CP, further action to be taken based on the failed rules.

### CROSS-REFERENCE TO RELATED APPLICATIONS

This application claims priority under 35 U.S.C. § 119(e) to U.S. Provisional Pat. App. No. 63/170,163, filed Apr. 2, 2022, titled “Support for Reporting Failure of Multiple Rules in PFCP Response Messages” which is hereby incorporated by reference in its entirety for all purposes. This application also hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. US20170273134A1, US20170127409A1 in their entirety.

### BACKGROUND

29.244-3rd Generation Partnership Project;

Technical Specification Group Core Network and Terminals;

Policy and Charging Control (PCC); Reference points

Spec 29.244 (g00)

Existing PFCP response messages have following fields as shown below:

TABLE 1
Information Elements in a PFCP Session Establishment Response

| | | | Appl. | | | | |
|---|---|---|---|---|---|---|---|
| Information | | | Sx | Sx | Sx | | |
| elements | P | Condition/Comment | a | b | c | N4 | IE Type |
| Node ID | M | This IE shall contain the unique identifier of the sending | X | X | X | X | Node ID |
| | | Node. | | | | | |
| Cause | M | This IE shall indicate the acceptance or the rejection of | X | X | X | X | Cause |
| | | the corresponding request message. | | | | | |
| Offending IE | C | This IE shall be included if the rejection is due to a | X | X | X | X | Offending IE |
| | | conditional or mandatory IE missing or faulty. | | | | | |
| UP F-SEID | C | This IE shall be present if the cause is set to “Request | X | X | X | X | F-SEID |
| | | accepted (success)”. When present, it shall contain the | | | | | |
| | | unique identifier allocated by the UP function identifying | | | | | |
| | | the session. | | | | | |
| Created PDR | C | This IE shall be present if the cause is set to “success” | X | X | — | X | Created PDR |
| | | and the UP function was requested to allocate a local F- | | | | | |
| | | TEID or a UE IP address/prefix for the PDR. | | | | | |
| | | When present, this IE shall contain the PDR information | | | | | |
| | | associated to the PFCP session. There may be several | | | | | |
| | | instances of this IE. | | | | | |
| | | See table 7.5.3.2-1. | | | | | |
| Load Control | O | The UP function may include this IE if it supports the load | X | X | X | X | Load Control |
| Information | | control feature and the feature is activated in the network. | | | | | Information |
| | | See Table 7.5.3.3-1. | | | | | |
| Overload Control | O | During an overload condition, the UP function may | X | X | X | X | Overload Control |
| Information | | include this IE if it supports the overload control feature | | | | | Information |
| | | and the feature is activated in the network. | | | | | |
| | | See Table 7.5.3.4-1. | | | | | |
| SGW-U FQ-CSID | C | This IE shall be included according to the requirements in | X | — | — | — | FQ-CSID |
| | | clause 23 of 3GPP TS 23.007 [24]. | | | | | |
| PGW-U FQ-CSID | C | This IE shall be included according to the requirements in | — | X | — | — | FQ-CSID |
| | | clause 23 of 3GPP TS 23.007 [24]. | | | | | |
| Failed Rule ID | C | This IE shall be included if the Cause IE indicates a | X | X | X | X | Failed Rule ID |
| | | rejection due to a rule creation or modification failure. | | | | | |
| Created Traffic | C | This IE shall be present if the cause is set to “success” | X | X | — | X | Created Traffic |
| Endpoint | | and the UP function was requested to allocate a local F- | | | | | Endpoint |
| | | TEID or a UE IP address/prefix in a Create Traffic | | | | | |
| | | Endpoint IE. When present, it shall contain the local F- | | | | | |
| | | TEID or UE IP address/prefix to be used for this Traffic | | | | | |
| | | Endpoint. | | | | | |
| | | There may be several instances of this IE. | | | | | |

TABLE 2
Information Elements in a PFCP Session Modification Response

| | | | Appl. | | | | |
|---|---|---|---|---|---|---|---|
| Information | | | Sx | Sx | Sx | | |
| elements | P | Condition/Comment | a | b | c | N4 | IE Type |
| Cause | M | This IE shall indicate the acceptance or the rejection of | X | X | X | X | Cause |
| | | the corresponding request message. | | | | | |
| Offending IE | C | This IE shall be included if the rejection is due to a | X | X | X | X | Offending IE |
| | | conditional or mandatory IE missing or faulty. | | | | | |
| Created PDR | C | This IE shall be present if the cause is set to “success”, | X | X | — | X | Created PDR |
| | | new PDR(s) were requested to be created and the UP | | | | | |
| | | function was requested to allocate the local F-TEID for | | | | | |
| | | the PDR(s). | | | | | |
| | | When present, this IE shall contain the PDR information | | | | | |
| | | associated to the PFCP session. | | | | | |
| | | See Table 7.5.3.2-1. | | | | | |
| Load Control | O | The UP function may include this IE if it supports the load | X | X | X | X | Load Control |
| Information | | control feature and the feature is activated in the network. | | | | | Information |
| | | See Table 7.5.3.3-1. | | | | | |
| Overload Control | O | During an overload condition, the UP function may | X | X | X | X | Overload Control |
| Information | | include this IE if it supports the overload control feature | | | | | Information |
| | | and the feature is activated in the network. | | | | | |
| Usage Report | C | This IE shall be present if: | X | X | X | X | Usage Report |
| | | the Query URR IE was present or the QAURR | | | | | |
| | | flag was set to “1” in the PFCP Session Modification | | | | | |
| | | Request, | | | | | |
| | | traffic usage measurements for that URR | | | | | |
| | | are available at the UP function, and | | | | | |
| | | the UP function decides to return some or all of | | | | | |
| | | the requested usage reports in the PFCP Session | | | | | |
| | | Modification Response. | | | | | |
| | | This IE shall be also present if: | | | | | |
| | | a URR or the last PDR associated to a URR | | | | | |
| | | has been removed, | | | | | |
| | | non-null traffic usage measurements for that | | | | | |
| | | URR are available in the UP function, and | | | | | |
| | | the UP function decides to return some or all of | | | | | |
| | | the related usage reports in the PFCP Session | | | | | |
| | | Modification Response (see clause 5.2.2.3.1). | | | | | |
| | | Several lEs within the same IE type may be present to | | | | | |
| | | represent a list of Usage Reports. | | | | | |
| Failed Rule ID | C | This IE shall be included if the Cause IE indicates a | X | X | X | X | Failed Rule ID |
| | | rejection due to a rule creation or modification failure. | | | | | |
| Additional | C | This IE shall be included if the Query URR IE was present | X | X | X | X | Additional |
| Usage Reports | | or the QAURR flag was set to “1” in the PFCP Session | | | | | Usage Reports |
| Information | | Modification Request, and usage reports need to be sent | | | | | Information |
| | | in additional PFCP Session Report Request messages | | | | | |
| | | (see clause 5.2.2.3.1). | | | | | |
| | | When present, this IE shall either indicate that additional | | | | | |
| | | usage reports will follow, or indicate the total number of | | | | | |
| | | usage reports that need to be sent in PFCP Session | | | | | |
| | | Report Request messages. | | | | | |
| Created/Updated | C | This IE shall be present if the cause is set to “success”, | X | X | — | X | Created Traffic |
| Traffic Endpoint | | Traffic Endpoint(s) were requested to be created or | | | | | Endpoint |
| | | updated, and the UP function was requested to allocate | | | | | |
| | | the local F-TEID for the Traffic Endpoint(s). | | | | | |
| | | When present, this IE shall contain the Traffic Endpoint | | | | | |
| | | information associated to the PFCP session. | | | | | |
| | | See Table 7.5.3.5-1. | | | | | |

Failed Rule ID

The Failed Rule ID IE type shall be encoded as shown in Table 3. It shall identify the Rule which failed to be created or modified.

### SUMMARY

A method, computer readable media and a system are disclosed to identify a mechanism to be able to supply multiple “Failed Rule ID” in a single PFCP response message from User Plane (UP) to Control Plane (CP) via the Sx interface for 4G and via the N4 interface for 5G.

In one embodiment, a method for operating a wireless network device including a User Plane (UP) and a Control Plane (CP) in communication with the UP, includes configuring, by the CP, multiple rules in the UP; identifying, by the UP, multiple failed rule Identifiers (IDs); supplying, in a single Packet Forwarding Control Protocol (PFCP) response message from the UP to a CP, the multiple failed rule IDs; and determining, by the CP, further action to be taken based on the failed rules.

In another embodiment a non-transitory computer-readable medium containing instructions for operating a wireless network device including a User Plane (UP) and a Control Plane (CP) in communication with the UP which, when executed, cause the device to perform steps including configuring, by the CP, multiple rules in the UP; identifying, by the UP, multiple failed rule Identifiers (IDs); supplying, in a single Packet Forwarding Control Protocol (PFCP) response message from the UP to the CP, the multiple failed rule IDs; and determining, by the CP, further action to be taken based on the failed rules.

In another embodiment a network device includes a User Plane (UP); a Control Plane (CP) in communication with the UP, wherein the CP configures multiple rules in the UP; wherein the UP identifies multiple failed rule Identifiers (IDs) and supplies, in a single Packet Forwarding Control Protocol (PFCP) response message from the UP to a CP, the multiple failed rule IDs; and wherein the CP determines further action to be taken based on the failed rules

### BRIEF DESCRIPTION OF THE DRAWINGS

FIG. 1 is a diagram of a network device, in accordance with some embodiments.

FIG. 2 is a flow diagram of a method for reporting failure of multiple rules in a PFCP message, in accordance with some embodiments.

FIG. 3 is a schematic network architecture diagram for 3G and other-G prior art networks.

FIG. 4 is an enhanced eNodeB for performing the methods described herein, in accordance with some embodiments.

FIG. 5 is a coordinating server for providing services and performing methods as described herein, in accordance with some embodiments.

### DETAILED DESCRIPTION

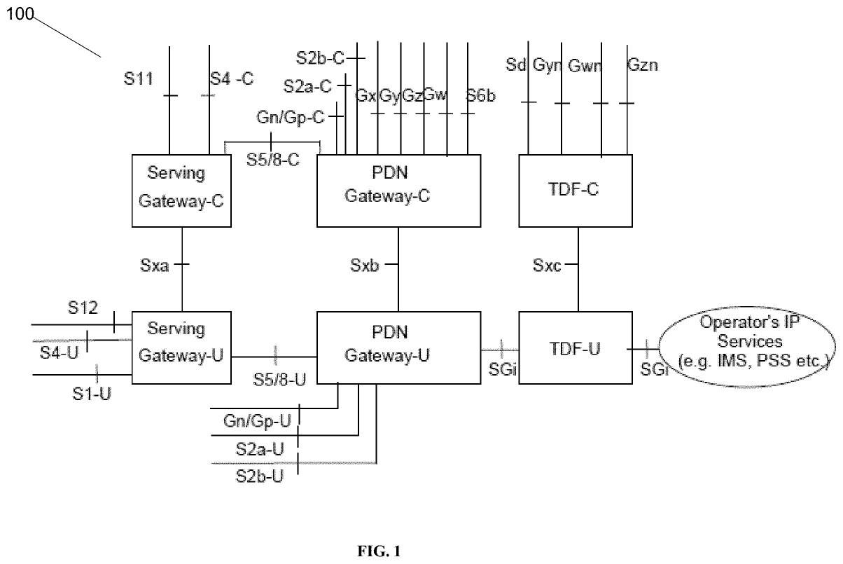

The present document specifies the Packet Forwarding Control Protocol (PFCP) used on the interface between the control plane and the user plane function. A system diagram 100 is shown in FIG. 1. “-C” means control plane; “-U” means user plane.

PFCP shall be used over:
the Sxa, Sxb, Sxc and the combined Sxa/Sxb reference points specified in 3GPP TS 23.214 [2].
the Sxa′ and Sxb′ reference points specified in 3GPP TS 33.107 [20]. In the rest of this specification, no difference is made between Sxa and Sxa′, or between Sxb and Sxb′. The Sxa′ and Sxb′ reference points reuse the protocol specified for the Sxa and Sxb reference points, but comply in addition with the security requirements specified in clause 8 of 3GPP 33.107 [20].
the N4 interface specified in 3GPP TS 23.501 [28] and 3GPP TS 23.502 [29].

(All of the 3GPP technical specifications referenced herein are hereby incorporated by reference.)

Current specifications of 29.244 for CP to UP communications provide CP with measures to configure multiple rules in UP in a single “PFCP Session Establishment/Modification Request”. In case of predefined rules, this can be achieved via multiple instances of the “Activate Predefined Rules” IE inside the “Create/Update PDR” IE. And, in case of dynamic rules, this can be achieved via multiple instances of the “SDF Filter” IE present inside the “PDI IE” of “Create/Update PDR” IE. Note that, these multiple rules being installed/updated in a single message can belong to one/more PDRs of the same PFCP Session.

But, in case of failure, specs allow only one “Failed Rule ID” to be reported by UP to CP even when multiple rules could have failed. This leads to following problems in case of partial success:

When multiple rule installations succeed and a few of them fail, the UP can report only one Failed Rule ID in the “PFCP Session Establishment/Modification Response” message which can be mapped to a single PDR failure only. As a result, other Rules/SDFs for which install/update has failed and which could belong to different PDRs of the same PFCP Session cannot be reported.

There is no mechanism to report these additional failed rules information independently via UP initiated message “PFCP Session Report Request”. So, the information of additional rules that failed to install/update is kind of lost. Even if such a mechanism existed in “PFCP Session Report Request”, it would mean a separate message had to be sent adding to network overhead.

In case of multiple failures where external entity like PCRF/OCS/OFCS is interested in exact set of rules installed/failed, this limitation means that correct information cannot be passed from UP to CP and hence cannot be passed to PCRF/OCS/OFCS. With this approach, the CP application is kind of forced to assume all rules failed even when one failed as all other failures cannot be known.

This behavior can impact charging if CP & hence PCRF/OCS/OFCS continue the session assuming only single rule failed (or don't have knowledge of failed rules) and the traffic matching those non-reported failed rules is charged differently than expected.

An example is described below:

Assume that predefined rules R1, R2, R3, R4 and R5 are to be to be installed on the UP. So, CP would send all these rule names under “Activate Predefined Rules” IE of “Create/Update PDR IE” of a “PFCP Session Establishment/Modification Request” message. Assume that R4 and R5 belong to different PDRs of the same PFCP session.

Assume that R1, R2, R3 succeed while R4, R5 fail.

So, the current mechanism allows only one PDR ID to be reported as failed under “Failed Rule ID”. Since R4 and R5 belong to different PDRs, only one of these PDR IDs can be reported as failed while the failure of the other PDR ID would never be known to CP and hence to PCRF/OCS/OFCS.

The solution to above problems is extending the “PFCP Session Establishment/Modification Response” messages with support for reporting multiple instances of the “Failed Rule ID” IE. As a result, the onus of partial success handling falls rightly onto CP.

The above addition solves the prior-listed problems in following manner:

By having multiple instances of “Failed Rule ID” in the “PFCP Session Establishment/Modification Response”, UP can report multiple failed PDR IDs to CP.

So, the CP would have complete picture of all the rules installed/failed and can take necessary relevant action.

Since existing IE of “Failed Rule ID” within “Create/Update PDR” IE of existing messages “PFCP Session Establishment/Modification Response” is being enhanced, no new message must be introduced.

Since CP is rightly informed of all the failed rule IDs (PDR IDs), it can then inform PCRF/OCS/OFCS of the failed rules across PDRs without any issues. Thus, PCRF/OCS/OFCS can take informed action based on knowledge of exact rules installed/failed.

Since CP & hence PCRF/OCS/OFCS are aware of all the failed rules, they can take change charging parameters as needed to address the failed rules and make sure that the session is charged as expected.

### Example (Same as Above with Mentioned Solution)

Assume that predefined rules R1, R2, R3, R4 and R5 are to be to be installed on the UP. So, CP would send all these rule names under “Activate Predefined Rules” IE of “Create/Update PDR IE” of a “PFCP Session Establishment/Modification Request” message. Assume that R4 and R5 belong to different PDRs of the same PFCP session.

Assume that R1, R2, R3 succeed while R4, R5 fail.

So, with the proposed enhancement, failure of both the PDR IDs corresponding to rules R4 & R5 can be conveyed to CP in the existing “PFCP Session Establishment/Modification Response”.

As a result, CP can report it to PCRF/OCS/OFCS and either PCRF/OCS/OFCS or CP locally can decide what further action to take based on the rules failed.

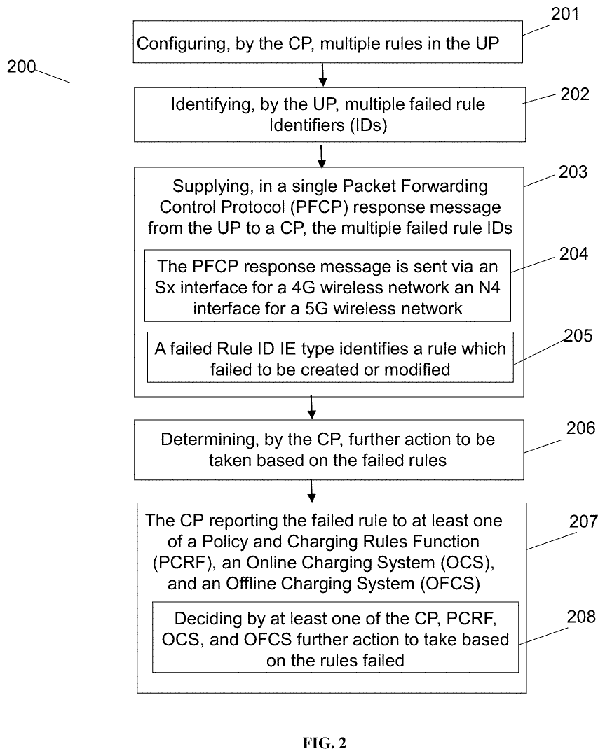

A flow chart of a particular embodiment of the presently disclosed method is depicted in FIG. 2. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language or hardware implementation. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 2, an example embodiment of a method 200 for reporting failure of multiple rules in PFCP response messages begins with processing block 201 which discloses configuring by the CP multiple rules in the UP. Processing block 202 shows identifying, by the UP, multiple failed rule Identifiers (IDs).

Processing block 203 recites supplying, in a single Packet Forwarding Control Protocol (PFCP) response message from the UP to a CP, the multiple failed rule IDs. As further recited in processing block 204 PFCP response message is sent via an Sx interface for a 4G wireless network and via an N4 interface for a 5G wireless network. Processing block 205 discloses wherein a failed Rule ID IE type identifies a rule which failed to be created or modified.

Processing block 206 shows determining, by the CP, further action to be taken based on the failed rules. Processing block 207 recites the CP reporting the failed rule to at least one of a Policy and Charging Rules Function (PCRF), an Online Charging System (OCS), and an Offline Charging System (OFCS). Processing block 208 discloses deciding by at least one of the CP, PCRF, OCS, and OFCS further action to take based on the rules failed.

Proposed changes to the following PFCP Response messages are as highlighted below:

TABLE 7.5.3.1-1
Information Elements in a PFCP Session Establishment Response

| | | | Appl. | | | | |
|---|---|---|---|---|---|---|---|
| Information | | | Sx | Sx | Sx | | |
| elements | P | Condition/Comment | a | b | c | N4 | IE Type |
| Node ID | M | This IE shall contain the unique identifier of the sending | X | X | X | X | Node ID |
| | | Node. | | | | | |
| Cause | M | This IE shall indicate the acceptance or the rejection of | X | X | X | X | Cause |
| | | the corresponding request message. | | | | | |
| Offending IE | C | This IE shall be included if the rejection is due to a | X | X | X | X | Offending IE |
| | | conditional or mandatory IE missing or faulty. | | | | | |
| UP F-SEID | C | This IE shall be present if the cause is set to “Request | X | X | X | X | F-SEID |
| | | accepted (success)”. When present, it shall contain the | | | | | |
| | | unique identifier allocated by the UP function identifying | | | | | |
| | | the session. | | | | | |
| Created PDR | C | This IE shall be present if the cause is set to “success” | X | X | — | X | Created PDR |
| | | and the UP function was requested to allocate a local F- | | | | | |
| | | TEID or a UE IP address/prefix for the PDR. | | | | | |
| | | When present, this IE shall contain the PDR information | | | | | |
| | | associated to the PFCP session. There may be several | | | | | |
| | | instances of this IE. | | | | | |
| | | See table 7.5.3.2-1. | | | | | |
| Load Control | O | The UP function may include this IE if it supports the load | X | X | X | X | Load Control |
| Information | | control feature and the feature is activated in the network. | | | | | Information |
| | | See Table 7.5.3.3-1. | | | | | |
| Overload Control | O | During an overload condition, the UP function may | X | X | X | X | Overload Control |
| Information | | include this IE if it supports the overload control feature | | | | | Information |
| | | and the feature is activated in the network. | | | | | |
| | | See Table 7.5.3.4-1. | | | | | |
| SGW-U FQ-CSID | C | This IE shall be included according to the requirements in | X | — | — | — | FQ-CSID |
| | | clause 23 of 3GPP TS 23.007 [24]. | | | | | |
| PGW-U FQ-CSID | C | This IE shall be included according to the requirements in | — | X | — | — | FQ-CSID |
| | | clause 23 of 3GPP TS 23.007 [24]. | | | | | |
| Failed Rule ID | C | This IE shall be included if the Cause IE indicates a | X | X | X | X | Failed Rule ID |
| | | rejection due to a rule creation or modification failure. | | | | | |
| | | Several lEs with the same IE type may be present to | | | | | |
| | | represent failure of multiple rules. | | | | | |
| Created Traffic | C | This IE shall be present if the cause is set to “success” | X | X | — | X | Created Traffic |
| Endpoint | | and the UP function was requested to allocate a local F- | | | | | Endpoint |
| | | TEID or a UE IP address/prefix in a Create Traffic | | | | | |
| | | Endpoint IE. When present, it shall contain the local F- | | | | | |
| | | TEID or UE IP address/prefix to be used for this Traffic | | | | | |
| | | Endpoint. | | | | | |
| | | There may be several instances of this IE. | | | | | |

TABLE 7.5.5.1-1:
Information Elements in a PFCP Session Modification Response

| | | | Appl. | | | | |
|---|---|---|---|---|---|---|---|
| Information | | | Sx | Sx | Sx | | |
| elements | P | Condition/Comment | a | b | c | N4 | IE Type |
| Cause | M | This IE shall indicate the acceptance or the rejection of | X | X | X | X | Cause |
| | | the corresponding request message. | | | | | |
| Offending IE | C | This IE shall be included if the rejection is due to a | X | X | X | X | Offending IE |
| | | conditional or mandatory IE missing or faulty. | | | | | |
| Created PDR | C | This IE shall be present if the cause is set to “success”, | X | X | — | X | Created PDR |
| | | new PDR(s) were requested to be created and the UP | | | | | |
| | | function was requested to allocate the local F-TEID for | | | | | |
| | | the PDR(s). | | | | | |
| | | When present, this IE shall contain the PDR information | | | | | |
| | | associated to the PFCP session. | | | | | |
| | | See Table 7.5.3.2-1. | | | | | |
| Load Control | O | The UP function may include this IE if it supports the load | X | X | X | X | Load Control |
| Information | | control feature and the feature is activated in the network. | | | | | Information |
| | | See Table 7.5.3.3-1. | | | | | |
| Overload Control | O | During an overload condition, the UP function may | X | X | X | X | Overload Control |
| Information | | include this IE if it supports the overload control feature | | | | | Information |
| | | and the feature is activated in the network. | | | | | |
| Usage Report | C | This IE shall be present if: | X | X | X | X | Usage Report |
| | | the Query URR IE was present or the QAURR | | | | | |
| | | flag was set to “1” in the PFCP Session Modification | | | | | |
| | | Request, | | | | | |
| | | traffic usage measurements for that URR are | | | | | |
| | | available at the UP function, and | | | | | |
| | | the UP function decides to return some or all of | | | | | |
| | | the requested usage reports in the PFCP Session | | | | | |
| | | Modification Response. | | | | | |
| | | This IE shall be also present if: | | | | | |
| | | a URR or the last PDR associated to a URR | | | | | |
| | | has been removed, | | | | | |
| | | non-null traffic usage measurements for that | | | | | |
| | | URR are available in the UP function, and | | | | | |
| | | the UP function decides to return some or all of | | | | | |
| | | the related usage reports in the PFCP Session | | | | | |
| | | Modification Response (see clause 5.2.2.3.1). | | | | | |
| | | Several lEs within the same IE type may be present to | | | | | |
| | | represent a list of Usage Reports. | | | | | |
| Failed Rule ID | C | This IE shall be included if the Cause IE indicates a | X | X | X | X | Failed Rule ID |
| | | rejection due to a rule creation or modification failure. | | | | | |
| | | Several lEs with the same IE type may be present to | | | | | |
| | | represent failure of multiple rules. | | | | | |
| Additional | C | This IE shall be included if the Query URR IE was present | X | X | X | X | Additional |
| Usage Reports | | or the QAURR flag was set to “1” in the PFCP Session | | | | | Usage Reports |
| Information | | Modification Request, and usage reports need to be sent | | | | | Information |
| | | in additional PFCP Session Report Request messages | | | | | |
| | | (see clause 5.2.2.3.1). | | | | | |
| | | When present, this IE shall either indicate that additional | | | | | |
| | | usage reports will follow, or indicate the total number of | | | | | |
| | | usage reports that need to be sent in PFCP Session | | | | | |
| | | Report Request messages. | | | | | |
| Created/Updated | C | This IE shall be present if the cause is set to “success”, | X | X | — | X | Created Traffic |
| Traffic Endpoint | | Traffic Endpoint(s) were requested to be created or | | | | | Endpoint |
| | | updated, and the UP function was requested to allocate | | | | | |
| | | the local F-TEID for the Traffic Endpoint(s). | | | | | |
| | | When present, this IE shall contain the Traffic Endpoint | | | | | |
| | | information associated to the PFCP session. | | | | | |
| | | See Table 7.5.3.5-1. | | | | | |

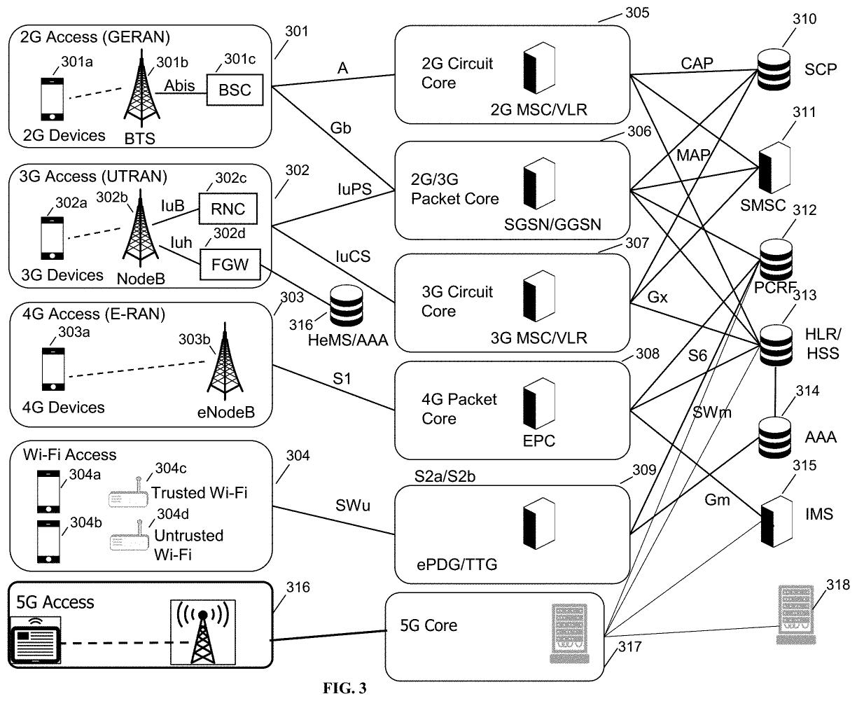

FIG. 3 is a schematic network architecture diagram 300 for 3G and other-G prior art networks. The diagram shows a plurality of “Gs,” including 2G, 3G, 4G, 5G and Wi-Fi. 2G is represented by GERAN 301, which includes a 2G device 301a, BTS 801b, and BSC 301c. 3G is represented by UTRAN 302, which includes a 3G UE 302a, nodeB 302b, RNC 302c, and femto gateway (FGW, which in 3GPP namespace is also known as a Home nodeB Gateway or HNBGW) 302d. 4G is represented by EUTRAN or E-RAN 303, which includes an LTE UE 303a and LTE eNodeB 303b. Wi-Fi is represented by Wi-Fi access network 304, which includes a trusted Wi-Fi access point 304c and an untrusted Wi-Fi access point 304d. The Wi-Fi devices 304a and 304b may access either AP 304c or 304d. In the current network architecture, each “G” has a core network. 2G circuit core network 305 includes a 2G MSC/VLR; 2G/3G packet core network 306 includes an SGSN/GGSN (for EDGE or UMTS packet traffic); 3G circuit core 307 includes a 3G MSC/VLR; 4G circuit core 308 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 330, the SMSC 331, PCRF 332, HLR/HSS 333, Authentication, Authorization, and Accounting server (AAA) 334, and IP Multimedia Subsystem (IMS) 335. An HeMS/AAA 336 is present in some cases for use by the 3G UTRAN. The diagram is used to indicate schematically the basic functions of each network as known to one of skill in the art, and is not intended to be exhaustive. For example, 5G core 317 is shown using a single interface to 5G access 316, although in some cases 5G access can be supported using dual connectivity or via a non-standalone deployment architecture.

Noteworthy is that the RANs 301, 302, 303, 304 and 336 rely on specialized core networks 305, 306, 307, 308, 309, 337 but share essential management databases 330, 331, 332, 333, 334, 335, 338. More specifically, for the 2G GERAN, a BSC 301c is required for Abis compatibility with BTS 301b, while for the 3G UTRAN, an RNC 302c is required for Iub compatibility and an FGW 302d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

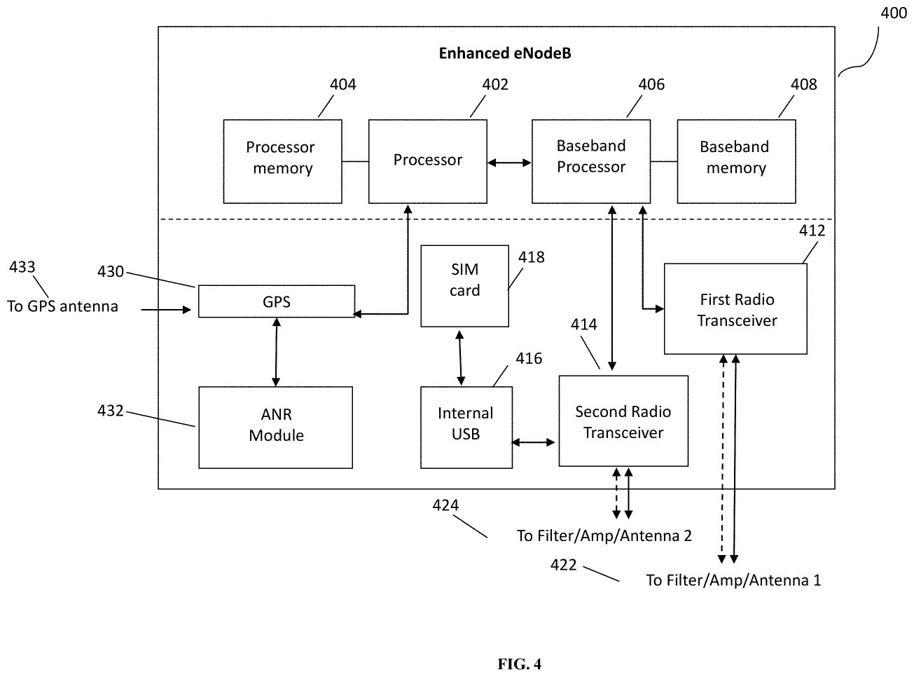

FIG. 4 is an enhanced eNodeB for performing the methods described herein, in accordance with some embodiments. Mesh network node 400 may include processor 402, processor memory 404 in communication with the processor, baseband processor 406, and baseband processor memory 408 in communication with the baseband processor. Mesh network node 400 may also include first radio transceiver 412 and second radio transceiver 414, internal universal serial bus (USB) port 416, and subscriber information module card (SIM card) 418 coupled to USB port 416. In some embodiments, the second radio transceiver 414 itself may be coupled to USB port 416, and communications from the baseband processor may be passed through USB port 416. The second radio transceiver may be used for wirelessly backhauling eNodeB 400.

Processor 402 and baseband processor 406 are in communication with one another. Processor 402 may perform routing functions, and may determine if/when a switch in network configuration is needed. Baseband processor 406 may generate and receive radio signals for both radio transceivers 412 and 414, based on instructions from processor 402. In some embodiments, processors 402 and 406 may be on the same physical logic board. In other embodiments, they may be on separate logic boards.

Processor 402 may identify the appropriate network configuration, and may perform routing of packets from one network interface to another accordingly. Processor 402 may use memory 404, in particular to store a routing table to be used for routing packets. Baseband processor 406 may perform operations to generate the radio frequency signals for transmission or retransmission by both transceivers 410 and 412. Baseband processor 406 may also perform operations to decode signals received by transceivers 412 and 414. Baseband processor 406 may use memory 408 to perform these tasks.

The first radio transceiver 412 may be a radio transceiver capable of providing LTE eNodeB functionality, and may be capable of higher power and multi-channel OFDMA. The second radio transceiver 414 may be a radio transceiver capable of providing LTE UE functionality. Both transceivers 412 and 414 may be capable of receiving and transmitting on one or more LTE bands. In some embodiments, either or both of transceivers 412 and 414 may be capable of providing both LTE eNodeB and LTE UE functionality. Transceiver 412 may be coupled to processor 402 via a Peripheral Component Interconnect-Express (PCI-E) bus, and/or via a daughtercard. As transceiver 414 is for providing LTE UE functionality, in effect emulating a user equipment, it may be connected via the same or different PCI-E bus, or by a USB bus, and may also be coupled to SIM card 418. First transceiver 412 may be coupled to first radio frequency (RF) chain (filter, amplifier, antenna) 422, and second transceiver 414 may be coupled to second RF chain (filter, amplifier, antenna) 424.

SIM card 418 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 400 is not an ordinary UE but instead is a special UE for providing backhaul to device 400.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 412 and 414, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 402 for reconfiguration.

A GPS module 430 may also be included, and may be in communication with a GPS antenna 432 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 432 may also be present and may run on processor 402 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

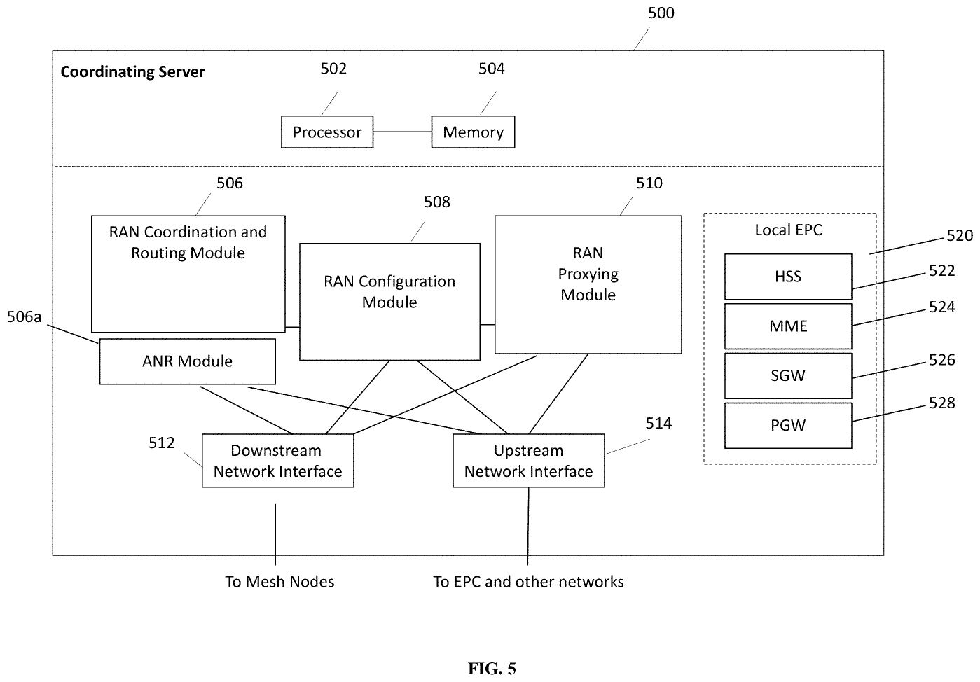

FIG. 5 is a coordinating server for providing services and performing methods as described herein, in accordance with some embodiments. Coordinating server 500 includes processor 502 and memory 504, which are configured to provide the functions described herein. Also present are radio access network coordination/routing (RAN Coordination and routing) module 506, including ANR module 506a, RAN configuration module 508, and RAN proxying module 510. The ANR module 506a may perform the ANR tracking, PCI disambiguation, ECGI requesting, and GPS coalescing and tracking as described herein, in coordination with RAN coordination module 506 (e.g., for requesting ECGIs, etc.). In some embodiments, coordinating server 500 may coordinate multiple RANs using coordination module 506. In some embodiments, coordination server may also provide proxying, routing virtualization and RAN virtualization, via modules 510 and 508. In some embodiments, a downstream network interface 512 is provided for interfacing with the RANs, which may be a radio interface (e.g., LTE), and an upstream network interface 514 is provided for interfacing with the core network, which may be either a radio interface (e.g., LTE) or a wired interface (e.g., Ethernet).

Coordinator 500 includes local evolved packet core (EPC) module 520, for authenticating users, storing and caching priority profile information, and performing other EPC-dependent functions when no backhaul link is available. Local EPC 520 may include local HSS 522, local MME 524, local SGW 526, and local PGW 528, as well as other modules. Local EPC 520 may incorporate these modules as software modules, processes, or containers. Local EPC 520 may alternatively incorporate these modules as a small number of monolithic software processes. Modules 506, 508, 510 and local EPC 520 may each run on processor 502 or on another processor, or may be located within another device.

In 5GC, the function of the SGW is performed by the SMF and the function of the PGW is performed by the UPF. The inventors have contemplated the use of the disclosed invention in 5GC as well as 5G/NSA and 5G. As applied to 5G/NSA, certain embodiments of the present disclosure operate substantially the same as the embodiments described herein for 5G. As applied to 5GC, certain embodiments of the present disclosure operate substantially the same as the embodiments described herein for 5G, except by providing an N4 communication protocol between the SMF and UPF to provide the functions disclosed herein.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof.

The word “cell” is used herein to denote either the coverage area of any base station, or the base station itself, as appropriate and as would be understood by one having skill in the art. For purposes of the present disclosure, while actual PCIs and ECGIs have values that reflect the public land mobile networks (PLMNs) that the base stations are part of, the values are illustrative and do not reflect any PLMNs nor the actual structure of PCI and ECGI values.

In the above disclosure, it is noted that the terms PCI conflict, PCI confusion, and PCI ambiguity are used to refer to the same or similar concepts and situations, and should be understood to refer to substantially the same situation, in some embodiments. In the above disclosure, it is noted that PCI confusion detection refers to a concept separate from PCI disambiguation, and should be read separately in relation to some embodiments. Power level, as referred to above, may refer to RSSI, RSFP, or any other signal strength indication or parameter.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for operating a wireless network device including a User Plane (UP) and a Control Plane (CP) in communication with the UP, comprising:
configuring, by the CP, multiple rules in the UP;
identifying, by the UP, multiple failed rule Identifiers (IDs);
supplying, in a single Packet Forwarding Control Protocol (PFCP) response message from the UP to a CP, the multiple failed rule IDs; and
determining, by the CP, further action to be taken based on the failed rules.

2. The method of claim 1 wherein the PFCP response message is sent via an Sx interface for a 4G wireless network.

3. The method of claim 1 wherein the PFCP response message is sent via an N4 interface for a 5G wireless network.

4. The method of claim 1 wherein a failed Rule ID IE type identifies a rule which failed to be created.

5. The method of claim 1 wherein a failed Rule ID IE type identifies a rule which failed to be modified.

6. The method of claim 1 further comprising the CP reporting the failed rule to at least one of a Policy and Charging Rules Function (PCRF), an Online Charging System (OCS), and an Offline Charging System (OFCS).

7. The method of claim 6 further comprising deciding by at least one of the PCRF, OCS, and OFCS further action to take based on the rules failed.

8. The method of claim 6 further comprising deciding, by the CP, further action to take based on the rules failed.

9. A non-transitory computer-readable medium containing instructions for operating a wireless network device including a User Plane (UP) and a Control Plane (CP) in communication with the UP which, when executed, cause the device to perform steps comprising:
configuring, by the CP, multiple rules in the UP;
identifying, by the UP, multiple failed rule Identifiers (IDs);
supplying, in a single Packet Forwarding Control Protocol (PFCP) response message from the UP to the CP, the multiple failed rule IDs; and
determining, by the CP, further action to be taken based on the failed rules.

10. The computer-readable medium of claim 9 further comprising instructions wherein the PFCP response message is sent via an Sx interface for a 4G wireless network.

11. The computer-readable medium of claim 9 further comprising instructions wherein the PFCP response message is sent via an N4 interface for a 5G wireless network.

12. The computer-readable medium of claim 9 w further comprising instructions wherein a failed Rule ID IE type identifies a rule which failed to be created.

13. The computer-readable medium of claim 9 further comprising instructions wherein a failed Rule ID IE type identifies a rule which failed to be modified.

14. The computer-readable medium of claim 9 further comprising further comprising instructions wherein the CP reports the failed rule to at least one of a Policy and Charging Rules Function (PCRF), an Online Charging System (OCS), and an Offline Charging System (OFCS).

15. The computer-readable medium of claim 14 further comprising instructions for deciding by at least one of the PCRF, OCS, and OFCS further action to take based on the rules failed.

16. The computer-readable medium of claim 14 further comprising instructions for deciding, by the CP, further action to take based on the rules failed.

17. A network device, comprising:
a User Plane (UP);
a Control Plane (CP) in communication with the UP,
wherein the CP configures multiple rules in the UP;
wherein the UP identifies multiple failed rule Identifiers (IDs) and supplies, in a single Packet Forwarding Control Protocol (PFCP) response message from the UP to a CP, the multiple failed rule IDs; and
wherein the CP determines further action to be taken based on the failed rules.

18. The device of claim 17 wherein the PFCP response message is sent via an Sx interface for a 4G wireless network and wherein the PFCP response message is sent via an N4 interface for a 5G wireless network.

19. The device of claim 17 wherein a failed Rule ID IE type identifies a rule which failed to be created or identifies a rule which failed to be modified.

20. The device of claim 17 wherein the CP reports the failed rule to at least one of a Policy and Charging Rules Function (PCRF), an Online Charging System (OCS), and an Offline Charging System (OFCS), and decides further action to take by the PCRF, OCS, OFCS or CP based on the rules failed.
